(19) United States
(12) Patent Application Publication
(10) Pub. No.: US 2014/0258917 A1
(43) Pub. Date: Sep. 11, 2014

(54) METHOD TO OPERATE A DEVICE IN A STERILE ENVIRONMENT

(71) Applicants: Peter Greif, Pinzberg/Gosberg (DE); Anja Jaeger, Fuerth (DE); Robert Kagermeier, Nuernberg (DE); Johann Maegerl, Erlangen (DE)

(72) Inventors: Peter Greif, Pinzberg/Gosberg (DE); Anja Jaeger, Fuerth (DE); Robert Kagermeier, Nuernberg (DE); Johann Maegerl, Erlangen (DE)

(21) Appl. No.: 14/200,487

(22) Filed: Mar. 7, 2014

(30) Foreign Application Priority Data
Mar. 7, 2013 (DE) 102013203918.2

(51) Int. Cl. G06F 3/01; G06F 3/0481

(52) U.S. Cl. CPC G06F 3/017; G06F 3/0481
USPC 715/781

(57) ABSTRACT

In a method and interface to operate a device in a sterile environment that is controlled without contact via a display panel and/or operating field, a first position of a gesture command within an operating field is detected, the first position is projected onto a first interaction region of the display panel. A first task is associated with the first interaction region. A second position of the same or an additional gesture command within the same or an additional operating field is detected onto a second interaction region of the display panel. A tolerance region is established within the second interaction region, and the first object is associated with the second interaction region when the projection of the second position is situated within the tolerance region, and another, second object is associated with the second interaction region when the projection of the second position lies outside of the tolerance region.

### BACKGROUND OF THE INVENTION

1. Field of the Invention

The invention concerns methods to operate a device in a sterile environment that is controlled without contact via a display panel and an operating field, as well as a user interface having a display panel and an operating field that is suitable for use in a sterile environment.

2. Description of the Prior Art

In interventional medicine, it frequently occurs that a physician would like to retrieve information from patient documents or archived images during an operation. Such actions can take place in a sterile OP area only with operating elements that have been elaborately covered beforehand with films. This procedure takes a great deal of time that the patient must continue to spend under anesthesia, and involves an increased risk of transferring germs from the contacted surfaces. In such sterile environments, it is possible to use devices that can be controlled without contact, such as with the aid of gestures or speech.

Given an application based on gestures, it is disadvantageous that many different gestures are required respectively for a number of operating functions, and these gestures must initially be learned by a user. Moreover, for some processes a two-handed gesture is necessary, which is not always possible in the interventional environment. For example, given workflows that require a repeated execution of a swiping gesture—such as leafing through 100 pages—a gesture operation is likewise not reasonable.

By contrast to this, speech control is less intuitive in cases in which parameters must be modified continuously (for example a zoom factor or a brightness of an image).

Given interaction with a screen-based operating surface, for example via freehand gestures, a haptic feedback is initially absent since no direct contact occurs. Given a freehand gesture, for the most part the operator has no feeling of to the extent that his or her gestures affect the position on the screen, and to what extent he or she must still move in a particular direction in order to arrive at the next control surface, for example.

The display of a cursor symbol is normally omitted given this approach. It is possible for the mouse pointer to be continuously displayed, so the operator is given feedback of to what position his or her gesture moves on the monitor. For example, the projection of the gesture position and at the position on the monitor takes place with a line extending from the heart to the hand, in the direction of the monitor, or with an absolute positioning via auxiliary devices that can determine the spatial position of the gesture. However, this type of display can be perceived as disruptive.

### SUMMARY OF THE INVENTION

An object of the invention is to provide a method and a user interface for improved operation of devices in a sterile environment.

According to the invention, a method to operate a device in a sterile environment that has a display panel forming a user interface via which the device is controlled without contact via at least one operating field includes the following steps.

A first position of a gesture command within an operating field is detected. The first position is projected onto a first interaction region of the display panel. A first task is associated with the first interaction region. At least one second position of the same or an additional gesture command within the same or an additional operating field is detected. The second position is projected at a second interaction region of the display panel. A tolerance region is established within the second interaction region. The first object is associated with the second interaction region when the projection of the second position is situated within this tolerance region. Another, second object is associated with the second interaction region when the projection of the second position lies outside of the tolerance region.

The gesture command is preferably a freehand gesture. The gesture command can also be a look (eye) gesture and/or a head gesture.

The object can be expressed in a defined function, in a menu with one or more menu points or a control surface behind which is located a function or, respectively, a menu. Other objects are also conceivable.

The operating comfort of the operator is increased via the invention. The operation with freehand gesture is predictable and intuitive since an immediate feedback provides certainty that the operator recognizes that his gesture has been tracked correctly and transferred to the display panel or, respectively, operating field.

In an embodiment , a movement direction from the first position to the second position can be rendered or displayed at the display device and/or operating device.

In a further embodiment, a movement direction can be rendered or displayed with a color path.

A feedback about the effect or position of his gesture is provided to the operator via the indication of the movement direction, for example with an arrow presentation or, respectively, a color path.

The invention also encompasses a user interface having a display panel and at least one operating field, suitable for use in a sterile environment, and having a gesture detection unit designed to detect a first position of a gesture command within the operating field and a second position of the same or an additional gesture command within the same or an additional operating field. The interface has a projection unit designed to project the first position onto a first interaction region of the display panel, with a first task being associated with the first interaction region, and to project the second position onto a second interaction region of the display panel. A processor establishes a tolerance region within the second interaction region, wherein the first task is associated with the second interaction region if the projection of the second position lies within the tolerance region, and a different, second task is to be associated with the second interaction region if the projection' of the second position lies outside of the tolerance region.

The device is suitable to execute the method according to the invention described above. The units of the device that are designed according to the invention are fashioned in software and/or firmware and/or hardware.

All described units can also be integrated into a single unit. In an embodiment of the control device according to the invention it is designed to operate a medical technology apparatus.

### BRIEF DESCRIPTION OF THE DRAWINGS

FIG. 1 schematically illustrates units of the device according to and embodiment of the invention.

FIG. 2 shows an example of the tolerance region.

FIGS. 3a and 3b indicate the movement direction with a color path.

### DESCRIPTION OF THE PREFERRED EMBODIMENTS

In order to simplify the workflow in an operating room, it must be possible to retrieve and process data and archived images directly on site at the operating table without thereby endangering sterility. This can be achieved via the gesture operation according to the invention.

The operator ergonomics can be decisively increased with various measures that yield a coherent, complete concept. Among these are a technique known as a full screen mapping that includes among other things, a projection of the gesture position onto the active operating field. Other such techniques are the intentional introduction of a hysteresis in the navigation via operating fields, and an indication of the movement direction of the gesture. The illustration of the projection can be assisted by a cursor.

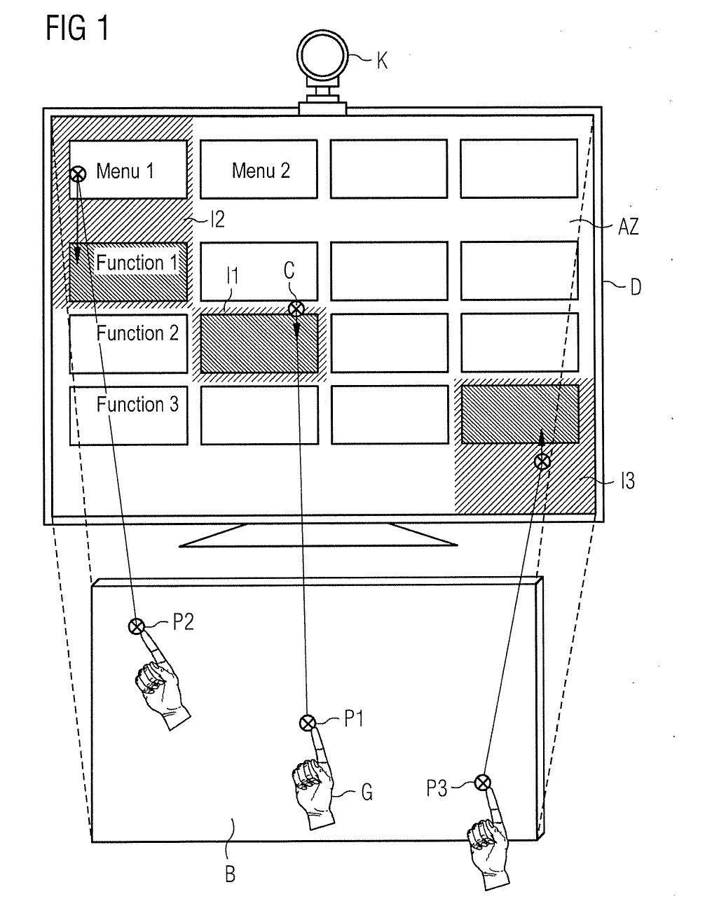

FIG. 1 illustrates the full screen mapping. A camera K is shown that can detect a gesture command or, respectively, a gesture G of an operator. Furthermore, an operating field B is shown that is, for the most part, virtual in design and enables gestures G in three dimensions. The camera K can detect the positions P1, P2 and P3 of the gestures. An operating field B is assigned to a display panel AZ, for example at a monitor or, respectively, display D, such that it can provide multiple operating fields for the operator, possibly at different locations in a sterile environment (an operating room, for example), which multiple operating fields can communicate with the display panel. The position (for example P1, P2, P3) of the gesture in the operating field is projected into an interaction region (for example 11, 12, 13) on the display panel AZ independently of whether the cursor C is presently active in a task (for example menu or, respectively, function) associated with the interaction region. In this way, an interaction region is always selected and there are no undefined spaces. If—given multiple operating fields—the operator should make a first gesture in a first operating field and an additional gesture in a different, second operating field, the respective positions belonging to the gestures can respectively be associated with the interaction regions. In the example P1, with 11 in the first operating field; with 12 in the same operating field in example P2; with 13 in a different, second operating field in example P3.

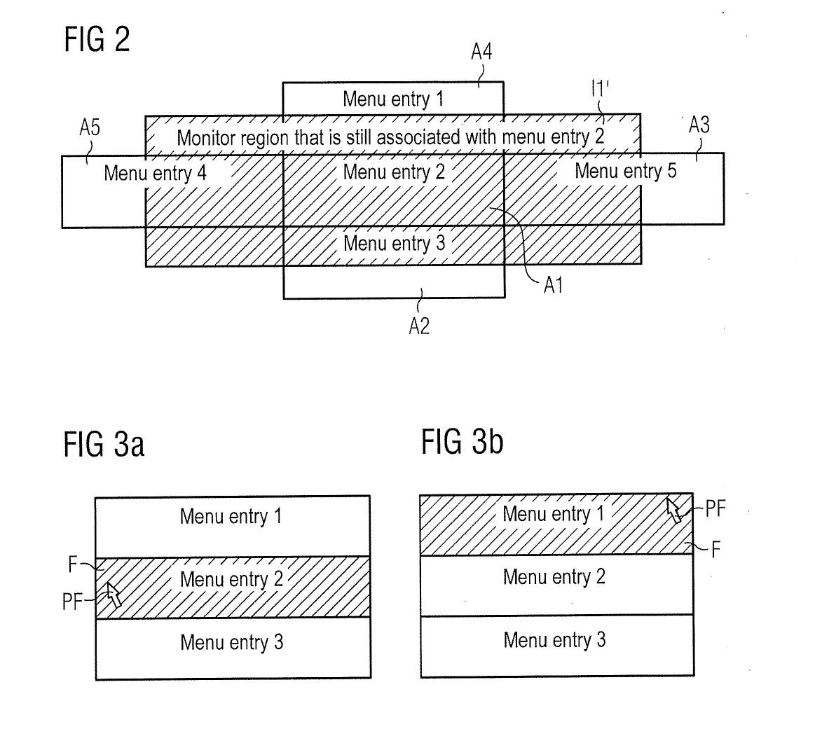

FIG. 2 explains the hysteresis to assist the navigation via the interaction region. An interaction region can be associated with tasks A1, A2, A3, A4, A5. These tasks can be represented as control surfaces as shown in FIG. 1, behind which are situated a menu or a function. The tasks can also represent menu entries as shown in FIG. 2. Upon switching from one interaction region to the next, this is first activated when the cursor is positioned outside of an established tolerance region, for example at more than 60% beyond the corresponding interaction region. In FIG. 2, a region I1′ is shown within which an object (for example the menu entry 1) still remains associated, although the interaction region 11 has been left and the cursor is located in the interaction region 12. Brief fluctuations in the signal thus do not lead to unwanted jumps of the cursor. The entire operation is thereby more steady.

Last, a feel for the cursor position can be communicated to the operator with an indication of the movement direction, as is shown in an example in FIGS. 3a and 3b. For this purpose, the edge of the interaction field on which the cursor moves is emphasized by color F or different brightness values. The movement direction from the first position to the second position on the display panel AZ can be provided via a depiction of an arrow PF.

The gesture is not limited to the freehand gesture described above. Viewing gestures (eye movement) and/or a head gesture can also be used. The detection of the position via a camera is then accordingly possibly designed with sensors to detect eye or head movements.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method to operate a controlled device in a sterile environment, comprising:
via a detector of an interface of said controlled device, detecting a first position of a contact-free gesture command within an operating field;
via a processor of said interface, projecting said first position onto a first interaction region of a display panel of said interface, and associating a first task with said first interaction region;
via said detector of said interface, detecting at least one second position of said contact-free gesture command, or of an additional contact-free gesture command, within said operating field or within an additional operating field;
via said processor, projecting the second position into a second a second interaction region of said display;
via said processor, establishing a tolerance region within said second interaction region;
via said processor, associating said first task with said second interaction region when said projection of said second position is situated within said tolerance region, and associating a different, second task with said second interaction region when the projection of the second position is outside of said tolerance region; and
emitting a control signal from said processor to said controlled device with a format for effecting control of said controlled device, dependent on at least one of said contact-free gesture command and said additional contact-free gesture command.

2. A method as claimed in claim 1 comprising detecting a movement direction from said first position to said second position via said receiver and said processor, and providing an indication of said movement at said display device.

3. A method as claimed in claim 1 comprising providing said indication of said movement at said display device with a color path.

4. A method as claimed in claim 1 comprising providing said indication of said movement at said display device with an arrow.

5. An Interface device for operating a controlled device in a sterile environment, said interface device comprising:
a display panel;
a detector that detects a first position of a contact-free gesture command within an operating field;
a processor configured to project said first position onto a first interaction region of said display panel, and to associate a first task with said first interaction region;
said detector being operable to detect at least one second position of said contact-free gesture command, or of an additional contact-free gesture command, within said operating field or within an additional operating field;
said processor being configured to project the second position into a second a second interaction region of said display;
said processor being configured to establish a tolerance region within said second interaction region;
said processor being configured to associate said first task with said second interaction region when said projection of said second position . is situated within said tolerance region, and to associate a different, second task with said second interaction region when the projection of the second position is outside of said tolerance region; and
said processor being configured to emit a control signal to said controlled device with a format for effecting control of said controlled device, dependent on at least one of said contact-free gesture command and said additional contact-free gesture command.

6. An interface device as claimed in claim 5 wherein said controlled device is a medical apparatus for implementing a medical examination or a medical treatment.
